(19) United States
(12) Patent Application Publication
(10) Pub. No.: US 2013/0344210 A1
(43) Pub. Date: Dec. 26, 2013

(54) Food Treatment Method

(71) Applicant: Jones-Hamilton Co., Walbridge, OH (US)

(72) Inventor: Carl J. Knueven, Bowling Green, OH (US)

(73) Assignee: Jones-Hamilton Co., Walbridge, OH (US)

(21) Appl. No.: 14/012,294

(22) Filed: Aug. 28, 2013

Related U.S. Application Data
(63) Continuation-in-part of application No. 13/478,262, filed on May 23, 2012.
(60) Provisional application No. 61/489,744, filed on May 25, 2011.

(51) Int. Cl. A23L 3/358

(52) U.S. Cl. CPC A23L 3/358
USPC 426/335; 424/709; 424/43

(57) ABSTRACT

A food treatment method involves applying alkali metal bisulfate to an outer surface of a food, by an application process beginning with the alkali metal bisulfate in a solution and ending with the alkali metal bisulfate at least partially crystallized when it contacts the food surface. In certain embodiments, the application process causes at least partial evaporation of solvent from the solution. For example, the application process may include forming droplets of the solution, and/or propelling the solution with a gas having a relative humidity not greater than 60% or a temperature of at least 20° C. In certain embodiments, the beginning solution is an aqueous solution including the alkali metal bisulfate at a concentration within a range from 30% to 80%.

### CROSS-REFERENCE TO RELATED APPLICATIONS

This application is a continuation-in-part of U.S. patent application Ser. No. 13/478,262, filed May 23, 2012, which in turn claims the benefit of United States Provisional Application No. 61/489,744, filed May 25, 2011, the disclosures of which are incorporated herein by reference.

### BACKGROUND OF THE INVENTION

This invention relates in general to food treatment methods, and in particular to methods for controlling the microbial contamination of foods and/or modifying the surface pH of foods.

Controlling the microbial contamination of foods for humans and animals is vitally important for reasons of safety and food preservation. For example, contamination of pet foods can cause illness of not only the pets but also their human owners, because the pet food is handled by humans and is present inside the home. The U.S. Food and Drug Administration monitors the prevalence of Salmonella in pet foods and ensures that contaminated foods are removed from interstate commerce.

Microbial control strategies in pet food manufacturing plants can be divided into three broad categories: 1) Prevent contamination from entering the facility. This can be done by controlling dust, managing the flow of equipment and humans, controlling pests, and sanitation of transport vehicles. 2) Reduce microbial growth within the plant. This can be done by discovering growth niches and reducing conditions that lead to growth. 3) Procedures designed to kill the microbes. Examples include thermal processing, alternative technologies, and antimicrobial interventions.

Among the antimicrobial interventions, oxidizing agents such as chlorine, hydrogen peroxide and peroxyacetic acid have been used in wash solutions. Organic acids such as citric acid have traditionally been used in human and animal foods to control microbes by lowering pH. The organic acids may require long contact times to reduce contamination, and they may be more effective on low levels of contamination. Also, the sour taste of the organic acids may cause palatability issues.

In addition to controlling microbial contamination, it is known to treat foods with acids to improve their taste or for other reasons. Jones-Hamilton Co., Walbridge, Ohio, manufactures and sells sodium bisulfate products in human food grade, pet food grade, and animal feed grade, as well as industrial grade. The following Jones-Hamilton patents disclose various products and methods using alkali metal bisulfate: U.S. Pat. Nos. 5,707,658; 5,773,063; 5,958,491; 6,132,792; 6,620,445; 7,048,803; and 7,097,861 which are incorporated by reference herein.

It could still be advantageous to provide another method of treating foods with alkali metal bisulfates for microbial control, taste improvement or other reasons.

### SUMMARY OF THE INVENTION

This invention relates to a food treatment method which comprises applying alkali metal bisulfate to an outer surface of a food, by an application process beginning with the alkali metal bisulfate in a solution and ending with the alkali metal bisulfate at least partially crystallized when it contacts the food surface. In certain embodiments, the application process causes at least partial evaporation of solvent from the solution. For example, the application process may include forming droplets of the solution. It may include propelling the solution with a gas having a relative humidity not greater than 60% and/or a temperature of at least 20° C. In certain embodiments, the beginning solution is an aqueous solution including the alkali metal bisulfate at a concentration within a range from 30% to 80%.

Various aspects of this invention will become apparent to those skilled in the art from the following detailed description of the preferred embodiment.

### DETAILED DESCRIPTION OF THE PREFERRED EMBODIMENT

The present invention relates to a food treatment method which comprises applying alkali metal bisulfate to an outer surface of a food. The process of applying the alkali metal bisulfate begins with the alkali metal bisulfate in a solution apart from the food, and it ends with the alkali metal bisulfate at least partially crystallized when it contacts the food surface.

The alkali metal bisulfate solution can be any type of solution of the alkali metal bisulfate in a suitable solvent. In certain embodiments the solvent is an aqueous solvent, such as water alone or mixed with other solvents(s) such as other polar solvents. In some aspects, the solvent or solvent mixture is generally recognized as safe for use with foods.

The alkali metal bisulfate can be included in any suitable concentration in the solution. In certain embodiments, the concentration of the alkali metal bisulfate in the solution is relatively high to make it easier to crystallize the alkali metal bisulfate during the application process. For example, in certain embodiments, the solution includes the alkali metal bisulfate at a percent concentration by mass within a range from 30% to 80%, more particularly from 40% to 60%, and most particularly from 45% to 55%.

The alkali metal bisulfate solution can be prepared by any suitable method. For example, sodium bisulfate is readily soluble in water at room temperature, and a solution can be prepared by adding the sodium bisulfate to a container of water and mixing with any suitable mixing equipment. The solution can be stored before use in any suitable container, tank, reservoir, or the like.

The alkali metal bisulfates include, for example, sodium bisulfate (i.e., sodium acid sulfate or sodium hydrogen sulfate), potassium bisulfate (i.e., potassium acid sulfate or potassium hydrogen sulfate), or mixtures thereof. Sodium bisulfate is usually in dry particle form. As mentioned above, Jones-Hamilton Co. manufactures and sells sodium bisulfate products in human food grade, pet food grade, and animal feed grade.

Any suitable application process can be used that begins with the alkali metal bisulfate in solution and ends with the alkali metal bisulfate at least partially crystallized when it contacts the food surface. For example, in certain embodiments the application process causes at least partial evaporation of solvent from the solution. Also, other methods are also known for causing crystallization to occur from a solution.

A process that includes crystallization by evaporation of solvent from the solution can be done using a variety of methods and equipment. For example, the process may include forming droplets of the solution, or more particularly it may include atomization of the solution. The process may include spraying or otherwise propelling or forming droplets of the solution. The process of atomization generally begins by forcing liquid (the solution) through a nozzle. The potential energy of the liquid along with the geometry of the nozzle causes the liquid to emerge as small ligaments which break up further into droplets. The droplet size distribution will depend on the nozzle type, liquid properties, nozzle capacity, spraying pressure, spray angle and other factors. The present method may include controlling the droplet size so that the droplets are large enough to avoid significant loss of droplets to the environment during the application process, and the droplets are small enough to allow enough evaporation of solvent for the alkali metal bisulfate to at least partially crystallize and achieve a good application on the food surface.

Spray nozzles come in many varieties, and are usually classified according to the specific mode of atomization they employ. Some examples of different types of spray nozzles include twin fluid, swirl, hydraulic, ultrasonic, rotary and electrostatic. As an alternative to spraying, the equipment may form a steam or fog of the solution in an enclosed area. Some examples of different types of equipment that may be used include high pressure atomizers or sprayers, compressed air paint sprayers, air brushes, and steam discs. Various different types of equipment are known for atomization or droplet formation of fluids on an industrial scale.

Evaporation of solvent from the solution can also be effected or increased by spraying or otherwise propelling the solution with a gas having a low relative humidity. The gas can be air or any other gas or gas mixture suitable for spraying the solution. In certain embodiments, the gas has a relative humidity not greater than 60%, more particularly not greater than 50%, and most particularly not greater than 40%. Methods are known for measuring relative humidity of gases.

Also, the evaporation of solvent from the solution can be effected or increased by increasing the temperature of the gas used to spray the solution. In certain embodiments, the gas has a temperature of at least 20° C., more particularly at least 30° C., and most particularly at least 40° C.

In certain embodiments, the alkali metal bisulfate solution includes other materials(s) for application to the food. For example, it may include a flavor enhancer to improve the taste of the food, a binder to improve the adhesion of the alkali metal bisulfate to the food, or a stabilizer to improve the stability of the food.

The alkali metal bisulfate is applied to the outer surface of the food—in other words, the outer boundary or perimeter, or the exterior face of the food. In certain embodiments, the crystals of alkali metal bisulfate are applied with adequate coverage of the food surface to be effective for the microbial control. For example, the applied crystals may cover substantially all regions of the surface although there may be some space and exposed surface between them. In certain embodiments, the coating has a thickness of from about 0.1 mm to about 1 mm.

The alkali metal bisulfate can be applied to the food in any suitable amount. In certain embodiments, the alkali metal bisulfate is applied in an amount from about 0.1% to about 5% by weight of the food, more particularly from about 0.% to about 2%, and most particularly from about 0.2% to about 0.5%.

In certain embodiments, after the application process, the food is maintained in an environment having a low humidity, for example a relative humidity not greater than 50%, or more particularly not greater than 40%, until the alkali metal bisulfate is completely crystallized. As long as the food is in a low humidity environment the remaining solvent may evaporate quickly. This may occur as part of the food manufacturing process on an industrial scale.

The food to which the alkali metal bisulfate is applied can be any type of human or animal food. A variety of different human foods are disclosed in U.S. Pat. Nos. 5,958,491 and 6,620,445 by Knueven, which relate to the use of alkali metal bisulfates as acidulants in foods.

In certain embodiments the food is a dry food, by which is meant a food having a water activity of not higher than about 0.90, more particularly not higher than about 0.70, and most particularly not higher than about 0.60. Different methods of measuring water activity are well known, such as a chilled mirror dew point method, or a method that uses resistance or capacitance sensors to measure relative humidity.

Some nonlimiting examples of dry pet foods include kibble, bits, treats, and biscuits for dogs or cats. A variety of different animal feeds are known. Some nonlimiting examples of dry human foods include cereals; dry snacks; dried meat, poultry, fish and seafood products; dried vegetables; nuts and associated butters; dry bakery products and ingredients; and powdered milk and eggs. Compositions and methods of making dry foods are well known.

In certain embodiments, the treatment of the food with the alkali metal bisulfate includes a microbial control effect on the food surface. This microbial control method can be used for controlling any types of microbes. The term “microbe” is synonymous with “microorganism,” and refers to any noncellular or unicellular (including colonial) organism, including all prokaryotes. Microbes include bacteria (including cyanobacteria), lichens, fungi, protozoa, virinos, viroids, viruses, phages, and some algae. In certain embodiments, the microbes are bacteria such as Salmonella, Escherichia coli, Campylobacter, Listeria, Pseudomonas, Acinetobacter, Moraxella, Alcaligenes, Flavobacterium, Erwinia, yeast, mold, or the like.

The microbial control method can have any suitable degree of effectiveness for controlling microbes. In certain embodiments, the method is effective to reduce Salmonella to non-detectable by one day after exposure of the food to this microbe.

In certain embodiments, the alkali metal bisulfate is applied to control microbial recontamination of a food product that was earlier contaminated and then decontaminated. For example, the production of pet food kibble involves a high temperature extrusion step that kills Salmonella and other microbes present in the raw materials. However, the kibble can be recontaminated with microbes present in the processing environment after the extruder. The application of the alkali metal bisulfate after extrusion can control/prevent this recontamination by killing microbes that come into contact with the kibble.

In certain embodiments, the food treatment kills mites or other insect pests on the food. For example, mites are known to infect pet food.

The principle and mode of operation of this invention have been explained and illustrated in its preferred embodiment. However, it must be understood that this invention may be practiced otherwise than as specifically explained and illustrated without departing from its spirit or scope.

### EXAMPLE

A test is conducted using an aqueous solution of 50% sodium bisulfate that is atomized and applied to dog kibble. The solution can be atomized using a high pressure atomizer or a compress air paint sprayer. The relative humidity of the compressed air is less than 40%. In the application process, enough water evaporates from the atomized droplets so that the sodium bisulfate at least partially crystallizes into sodium bisulfate monohydrate before contacting the kibble.

After application of the sodium bisulfate, the kibble is tested for microbial control as measured by Salmonella count and aerobic count. The results are shown below.

50% SBS Solution - Salmonella

| | Salmonella | Salmonella | Salmonella |
|---|---|---|---|
| | count | count | count |
| Diet | Day 0 | Day 1 | Day 2 |
| Control | 4,500 | 2,800 | 600 |
| Diet 6 | n.d. | n.d. | n.d. |
| Diet 7 | n.d. | 180 | n.d. |
| Diet 8 | n.d. | n.d. | n.d. |

50% SBS Solution - Aerobic Plate Count

| | Aerobic | Aerobic | Aerobic |
|---|---|---|---|
| | count | count | count |
| Diet | Day 0 | Day 1 | Day 2 |
| Control | 16,000 | 26,000 | 4,400 |
| Diet 6 | 1,100 | 900 | 110 |
| Diet 7 | 530 | 1,800 | 60. |
| Diet 8 | 10 | 150 | n.d. |

Control - 7% fat, 1% flavor
Diet 6 - 7% fat, 1% flavor, 0.25% SBS Pet ®
Diet 7 - 7% fat, 1% flavor, 0.5% SBS Pet ®
Diet 8 - 7% fat, 1% flavor, 0.75% SBS Pet ®
n.d.—Not Detected
Method - FDA III, Detection limit 10

What is claimed is:

1. A food treatment method which comprises applying alkali metal bisulfate to an outer surface of a food, by an application process beginning with the alkali metal bisulfate in a solution and ending with the alkali metal bisulfate at least partially crystallized when it contacts the food surface.

2. The method of claim 1 wherein the application process causes at least partial evaporation of solvent from the solution.

3. The method of claim 2 wherein the application process includes forming droplets of the solution.

4. The method of claim 3 which includes controlling the droplet size so that the droplets are large enough to avoid significant loss of droplets to the environment during the application process, and the droplets are small enough to allow enough evaporation for the alkali metal bisulfate to at least partially crystallize

5. The method of claim 2 wherein the application process includes spraying the solution.

6. The method of claim 1 wherein the beginning solution is an aqueous solution including the alkali metal bisulfate at a percent concentration by mass within a range from 30% to 80%.

7. The method of claim 6 wherein the alkali metal bisulfate concentration is within a range from 40% to 60%.

8. The method of claim 2 wherein the application process includes propelling the solution with a gas having a relative humidity not greater than 60%.

9. The method of claim 8 wherein the relative humidity is not greater than 50%.

10. The method of claim 1 wherein the alkali metal bisulfate concentration is within a range from 40% to 60% and the application process includes propelling the solution with a gas having a relative humidity not greater than 40%.

11. The method of claim 2 wherein the application process includes propelling the solution with a gas having a temperature of at least 20° C.

12. The method of claim 11 wherein the temperature is at least 30° C.

13. The method of claim 1 further comprising, after the application process, maintaining the food in an environment having a relative humidity not greater than 50% until the alkali metal bisulfate is completely crystallized.

14. The method of claim 1 wherein the food treatment has a microbial control effect on the food.

15. The method of claim 1 wherein the food treatment kills mites on the food.

16. The method of claim 1 wherein the alkali metal bisulfate comprises sodium bisulfate.

17. The method of claim 1 wherein the alkali metal bisulfate is applied in an amount from 0.1% to 5% by weight of the food.

18. The method of claim 1 wherein the food is a dry food.

19. A food treatment method which comprises applying alkali metal bisulfate to an outer surface of a food, by an application process beginning with the alkali metal bisulfate in a solution and ending with the alkali metal bisulfate at least partially crystallized when it contacts the food surface, the application process causing at least partial evaporation of solvent from the solution, the application process including forming droplets of the solution and propelling the droplets with a gas having a relative humidity not greater than 60%, and wherein the beginning solution is an aqueous solution including the alkali metal bisulfate at a percent concentration by mass within a range from 40% to 60%.

20. The method of claim 19 wherein the alkali metal bisulfate comprises sodium bisulfate.
